(19) United States
(12) Patent Application Publication
(10) Pub. No.: US 2008/0313530 A1
(43) Pub. Date: Dec. 18, 2008

(54) Method and Apparatus for Making Devices on a Local Network Remotely-Accessible

(76) Inventors: Yu Kyoung Song, Gyeonggi-do (KR); Kyung Ju Lee, Kyunggi-do (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 11/912,114

(22) PCT Filed: Apr. 19, 2006
(86) PCT No.: PCT/KR2006/001453

§ 371 Date: Jul. 9, 2008

Related U.S. Application Data
(60) Provisional application No. 60/673,253, filed on Apr. 19, 2005.

(30) Foreign Application Priority Data
Jun. 3, 2005 (KR) 10-2005-0047768

(51) Int. Cl. G06F 17/00

(52) U.S. Cl. 715/234

(57) ABSTRACT

The present invention relates to method and apparatus for enabling remote query and control for a device on a home network. A starting control point or a gateway of home network in accordance with the present invention makes out a document of device list that shows a device in association with location information of a presentation page written in a device descriptor received from at least one of devices connected to a home network; and provides the document for a general browser to interpret/process in order that device list of the home network is displayed by the general browser when the general browser is executed.

### 1. TECHNICAL FIELD

The present invention relates to method and apparatus for enabling remote query and control for a device on a home network.

### 2. BACKGROUND ART

As an increasing number of electronic appliances such as video or audio apparatuses or PCs have been used in a home and digital techniques have become dominant in video and audio signal processing, the need for communication between home electronic appliances or communication with other networks is also increasing. In addition, the demand for controlling home electronic appliances through a single apparatus such as a PDA is also increasing.

To meet the demand, home networking technology has emerged for connecting home electronic appliances such as digital TVs or DVD players. The UPnP (Universal Plug and Play) is a key technology required for implementing the home network.

FIG. 1 shows an exemplary UPnP network. According to the UPnP specification, every home network requires an apparatus called the IGD (Internet Gateway Device) 20, which assigns addresses to elements or nodes 10, 11, 12 connected to the network and also acts as a gateway to outer networks, e.g., the Internet. The IGD 20 can be a stand-alone device or embedded within another apparatus such as a PC or refrigerator.

Each UPnP network has a control point (CP) 10, which discovers and controls devices connected to the UPnP network, processes events, and enables remote query and control through the provided user interface (UI). Precisely speaking, the control point is a control application program executed on a device. However, the device executing the control application is also referred to as the control point.

The control point 10 provides the UPnP discovery service, which finds electronic devices connected to the home network by notifying the home network of a search message and obtains information regarding the found devices. The control point 10 then provides the obtained information for a user through a user interface specially designed for the home network, thereby allowing the user to request a certain service using the user interface.

The user of the home network may want to request remote query or control for a device existing on the home network from outside the home network. In this case, however, the user cannot access the home network through the Internet simply by using the control point 10 outside the home network same as inside the home network.

### 3. DISCLOSURE OF THE INVENTION

It is an object of the present invention to enable a general browser to make remote query and control for a device on a home network.

It is another object of the present invention to enable a user interface for query or control for a device on a home network to be used at remote as it is.

In one method in accordance with the invention, a remote apparatus extracts information on the location of presentation information from a device description provided by each of a plurality of devices on a home network, creates a document listing devices each of which is associated with the extracted information on the location of presentation information in such a way that a browser can interpret the document, and invokes the browser to make the document to be interpreted/processed by the browser.

In another method of the invention, a gateway device on a home network extracts information on the location of presentation information from a device description provided by each of a plurality of devices on the home network, creates a document listing devices each of which is associated with the extracted information on the location of presentation information in such a way that a browser executed at a remote site can interpret the document, and provides the document for the browser so that the document can be interpreted and processed when the browser makes a request for a connection.

In one embodiment in accordance with the invention, the browser is a web browser executed on a PC or a notebook computer.

In another embodiment in accordance with the invention, the browser is a WAP browser executed on a PDA or a mobile phone.

In one embodiment in accordance with the invention, the document listing devices is written in a markup language such as html.

In another embodiment in accordance with the invention, a plurality of documents listing devices is created based on preset user access right information and one of the created plurality of documents is provided when the browser makes the request for a connection, depending on the user of the browser.

### 4. BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates an exemplary UPnP home network;

FIG. 2 illustrates an exemplary home network in accordance with one embodiment of the present invention;

FIGS. 3a and 3b illustrate exemplary formats of device description and service description provided by UPnP devices;

FIG. 4a illustrates an exemplary document for listing available devices, created based on device descriptions provided in accordance with the present invention;

FIG. 4b illustrates an exemplary screen output according to the document shown in FIG. 4a displayed by a browser; and

FIG. 5 illustrates an exemplary home network in accordance with another embodiment of the present invention.

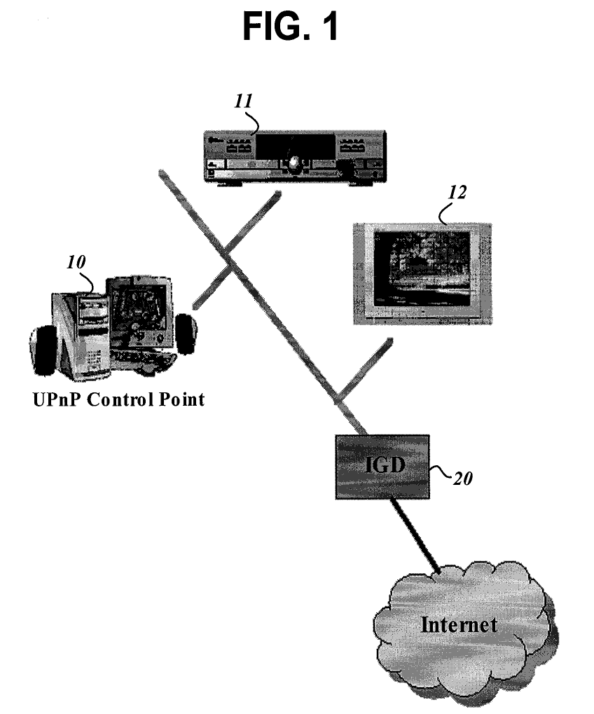

### 5. BEST MODE FOR CARRYING OUT THE INVENTION

In order that the invention may be fully understood, preferred embodiments thereof will now be described with reference to the accompanying drawings.

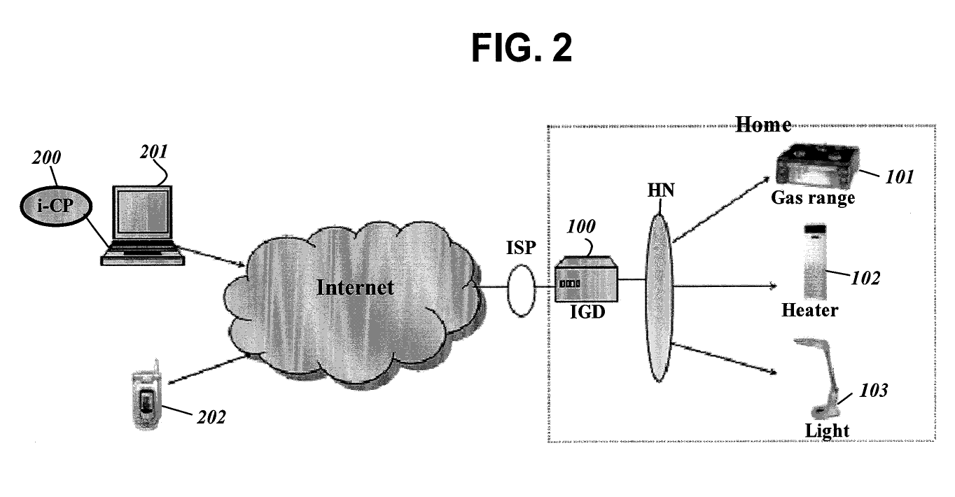

FIG. 2 shows an exemplary home network in accordance with one embodiment of the present invention. The network enables a remote access to a device on the network through a general web browser.

A remote user has an Internet-accessible notebook computer 201 in which a staring application 200 is installed. The starting application 200 is also called the starting control point. The notebook computer 201 has a public IP address for accessing the Internet. The user or the starting application 200 knows the public IP address of the IGD 100 of his/her home network. The IP address of the IGD 100, which is assigned by an ISP (Internet Service Provider), may be a dynamic IP address, in which case the user finds the dynamic IP address of the IGD 100 using an appropriate method. The method for finding the dynamic IP address has no relevance to the present invention and therefore the method is not described here.

The starting control point 200 performs the discovery procedure at startup by sending a search message, the header of which contains the public IP address of the IGD 100. The search message is received by the IGD 100 via the Internet and the IGD 100 notifies the home network of the search message after removing the IP header thereof by an address conversion process.

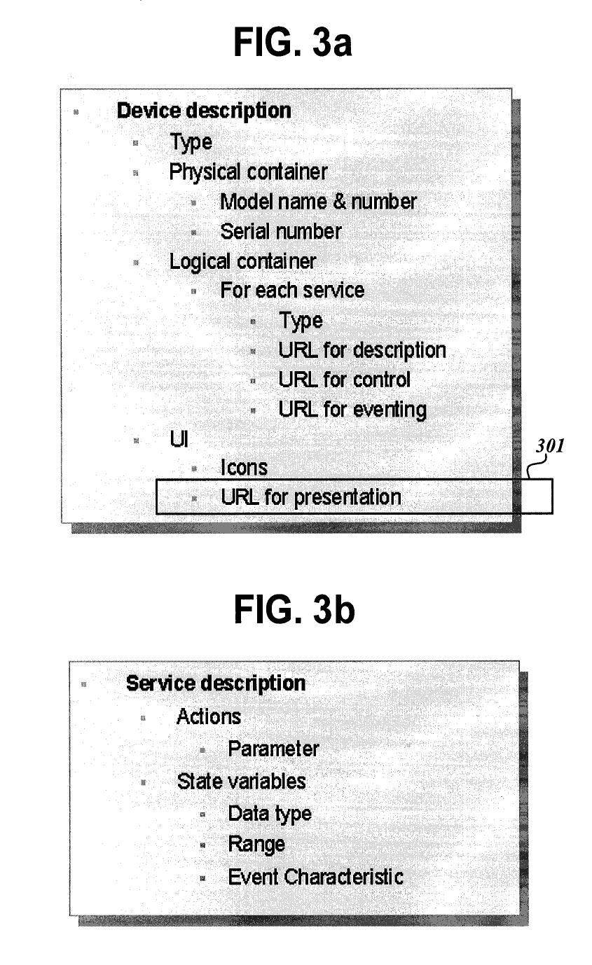

Every device on the network responds to the received message to notify its existence. The IGD 100 appends a header containing the IP address of the notebook computer 201 to each response message, thereby allowing the response message to be received by the starting control point 200 via the Internet. The starting control point 200 requests each of the devices which sent the response message to provide device description. Each device responsive to the request provides device description as illustrated in FIG. 3a and service description as illustrated in FIG. 3b for the starting control point 200.

In the case where a VPN client starts running on the notebook computer 201, one of private IP addresses available for devices on the home network is assigned to the notebook computer 201 by the IGD 100. As a result, the starting control point 200 and the general browser can communicate with devices on the home network through the VPN client as if the starting control point 200 were directly connected to the home network.

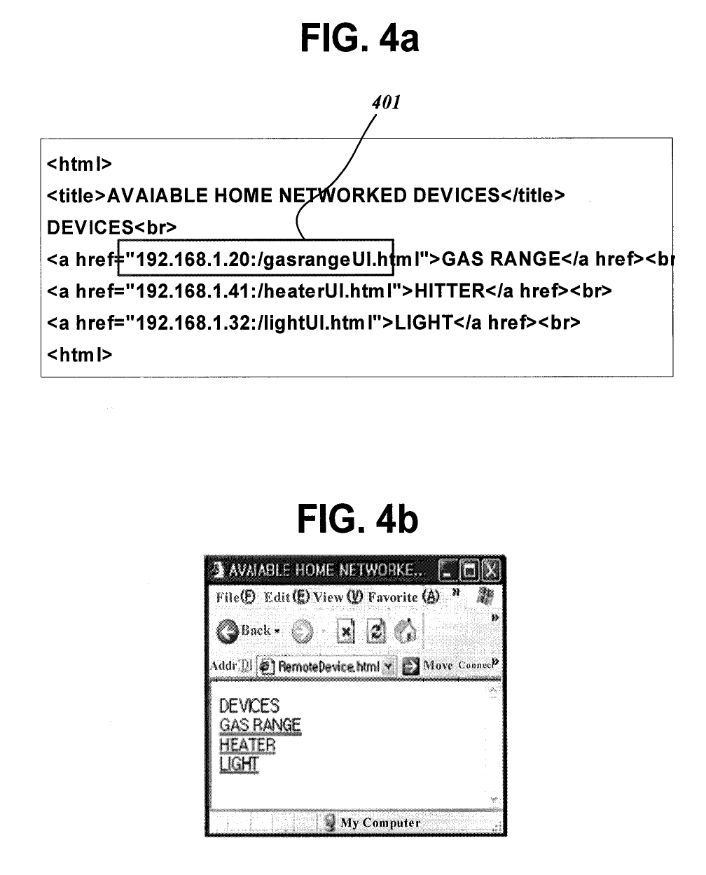

The starting control point 200 parses the device description received from each device to extract presentation information such as a URL (Universal Resource Locator) 301. Based on the obtained information, the starting control point 200 creates a markup-language document for listing URLs associated with devices (e.g., the html document as shown in FIG. 4a) and stores the document in a file. The html document is assigned an appropriate title (e.g., available home network devices) by the starting control point 200.

When the document is completed, the starting control point 200 invokes a general web browser installed in the notebook computer 201 with the document title as an input parameter. The web browser interprets the document whose title is provided as the input parameter and outputs the content thereof. FIG. 4b is the screen output of the web document shown in FIG. 4a, displayed by the web browser.

After the document is displayed as shown in FIG. 4b, the devices on the home network can be monitored and/or controlled through the web browser. If the user selects a device (e.g., gas range) from the output screen, the URL 401 in FIG. 4a corresponding to the selected gas range is transmitted to the gas range 101. The gas range 101 then provides a presentation page therefor, thereby enabling the web browser to display the presentation page on the screen. The presentation page includes available actions for queries or control operations for the selected device in the html format. If the user selects an item on the presentation page, the action corresponding to the selected item is transmitted to the device and therefore the selected action for query or control is executed.

The user may request remote query or control for a device on the home network through a mobile phone 202 or PDA. When making the document for listing devices on the network based on the device descriptions received in the aforementioned manner, the starting control point according to the present invention makes the document appropriate for wireless browsers (e.g., WAP document).

In another embodiment of the present invention, the IGD 100 acts as a VPN server and the notebook computer 201 executes a VPN client, thereby allowing the notebook computer 210 to utilize the user interface of the control point of the home network. When the VPN client starts running on the notebook computer 201, one of private IP addresses available for devices on the home network is assigned to the notebook computer 201 by the IGD 100. As a result, the starting control point 200 executed on the notebook computer 201 can communicate with devices on the home network through the VPN client as if the starting control point 200 were directly connected to the home network.

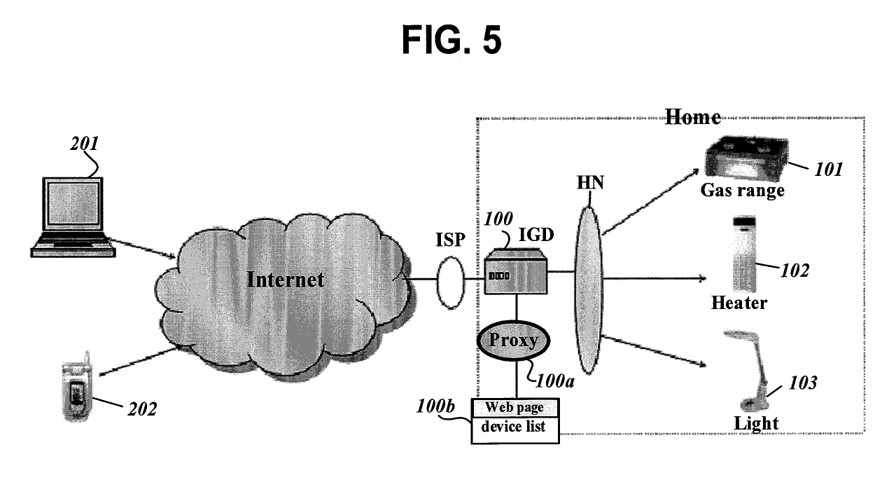

In yet another embodiment of the present invention, the IGD 100 creates a menu page for allowing remote access and provides the menu page for the browser. The hardware module or program for executing such a function may be separated from the IGD 100. The separated hardware module or program is generally called a proxy. The name, however, is not what the present invention proposes and thus other names may be used to refer to the module or program. FIG. 5 shows a home network in accordance with another embodiment of the present invention. As shown, the devices 201 and 202 which will access a device on the home network do not need to be equipped with the function of the starting control point. The devices 201 and 202 only require a general web browser.

In FIG. 5, a proxy 100a creates a search message and broadcasts the created search message to the home network. Every device on the home network responds to the message to inform its existence. The proxy 100a requests each of the devices which sent the response message to provide device description. Each device responsive to the request provides device description as illustrated in FIG. 3a and service description as illustrated in FIG. 3b for the proxy 10a.

The proxy 100a parses the device description received from each device to extract presentation information such as a URL (Universal Resource Locator) 301. Based on the obtained information, the proxy 100a creates a markup-language document for listing URLs associated with devices (e.g., the html document as shown in FIG. 4a) and stores the document in a file. The html document is assigned an appropriate title (e.g., available home network devices) by the proxy 100a.

If the general browser installed in the notebook computer 201 makes a request for connection to the IGD 100 after the document is completed, the IGD 100 relays the request to the proxy 100a after conducting a user authentication procedure. The proxy 100a then sends the document listing devices 100b to the general browser, in which case the proxy 100a acts as a web server. The general browser interprets the received web document, i.e., the list of devices on the home network, and displays the list as shown in FIG. 4b.

A remote user can monitor and/or control a device on the home network through a menu screen as shown in FIG. 4b displayed by the web browser. In this case, the proxy 100a acts as a web proxy. For example, if an HTTPGet( ) action containing the URL of a selected device is received, the proxy 100a returns the presentation page for the selected device, thereby allowing query and/or control for the selected device to be achieved through the presentation page.

The proxy 100a may create a plurality of documents for listing devices by organizing the devices found by the search procedure into several groups according to their users. For example, the proxy 100a may create a document listing device #1 and device #2 for user A and another document listing device #1 and device #3 for user B, based on information on remotely-accessible devices for each user, i.e., access right information, stored in the IGD 100. In this case, the proxy 100a provides different menu screens for different users and thereby prevents a user from accessing devices which are not listed on the menu associated with the user. As a result, control for selective access to devices on the home network from a remote place can be achieved.

The present invention allows a general web browser to access devices on a home network for remote query or control for the devices, thereby significantly improving the convenience of the home network.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A method for making at least one of a plurality of devices on a local network remotely-accessible, comprising the steps of:
(a) extracting information for presentation from a device description provided by each of the plurality of devices; and
(b) creating a document listing devices each of which is associated with the extracted information for presentation, the document being written in a language that can be interpreted by a browser.

2. The method of claim 1, further comprising the step of:
(c) invoking the browser and making the browser interpret/process the created document.

3. The method of claim 1, further comprising the step of:
(c) providing the created document for the browser when the browser makes a request for connection.

4. The method of claim 1, wherein the browser is a web browser or a WAP browser.

5. The method of claim 1, wherein the step (b) writes the document listing devices in a markup language.

6. The method of claim 1, further comprising the step of:
(c) requesting a presentation page corresponding to an item which a user selects from a screen output displayed through the browser's interpretation and processing of the created document, and interpreting, processing, and displaying the presentation page received according to the requesting.

7. The method of claim 6, wherein the presentation page designates actions for query and/or control for a corresponding device in a markup language.

8. The method of claim 7, further comprising the step of:
(d) invoking an action to one of the plurality of devices, the action being corresponding to an item which a user selects from the presentation page displayed by the step (c).

9. The method of claim 1, wherein the plurality of devices are devices which responded to a search message which had been sent to the local network prior to the step (a).

10. The method of claim 1, wherein the information for presentation is a URL.

11. An apparatus for accessing at least one of a plurality of devices on a local network through a global network, comprising a device which can communicate with the local network by connecting to the global network, the device including:
a browser for interpreting and processing a document written in a markup language; and
a starting application for creating a document listing devices each of which is associated with information for presentation contained in each device description received from at least one of the plurality of devices through the global network, and invoking the browser to interpret and process the created document.

12. The apparatus of claim 11, wherein the browser is a web browser or a WAP browser.

13. The apparatus of claim 11, wherein the browser further displays a page for selecting devices by interpreting and processing the created document, requests a presentation page corresponding to a device selected by a user, and interprets, processes, and displays the presentation page received according to the requesting.

14. The apparatus of claim 13, wherein the presentation page designates actions for query and/or control for the corresponding device in a markup language.

15. The apparatus of claim 14, wherein the browser further invokes an action to one of the plurality of devices, the action being corresponding to an item which a user selects from a screen output generated from interpretation of the presentation page.

16. The apparatus of claim 11, wherein the starting application receives the device description by making a request for the device description to at least one of the plurality of devices which responded to a search message which had been sent to the local network.

17. An apparatus for making at least one of a plurality of devices on a local network accessible from a remote site, comprising:
a gate device for sending a search message to the local network, for creating a document listing devices each of which is associated with information for presentation contained in each device description sent by at least one of the plurality of devices responsive to the search message, and for providing the created document for a browser when the browser makes a request for a connection from the remote site.

18. The apparatus of claim 17, wherein the browser is a web browser or a WAP browser.

19. The apparatus of claim 17, wherein the gate device receives the device description by making a request for the device description to at least one of the plurality of devices which responded to the search message.

20. The apparatus of claim 17, wherein the gate device creates a plurality of documents listing devices based on preset user access right information and provides one of the created plurality of documents when the browser makes the request for a connection, depending on a user of the browser.

21. The apparatus of claim 20, wherein at least two of the created plurality of documents have different lists of devices.
